(19) United States
(12) Patent Application Publication
(10) Pub. No.: US 2002/0184623 A1
(43) Pub. Date: Dec. 5, 2002

(54) Methods and apparatus for interactive television

(76) Inventors: Gregory A. Hodge, Decatur, GA (US); Bennie L. Gibson, Mableton, GA (US)

Correspondence Address: Finnegan, Henderson, Farabow,, Garrett & Dunner, L.L.P., 1300 I Street, N.W., Washington, DC, 20005-3315, US

(21) Appl. No.: 09/866,765

(22) Filed: May 30, 2001

(51) Int. Cl. H04N 5/445; G06F 13/00; G06F 3/00

(52) U.S. Cl. 725/37; 725/42; 725/39; 725/121

(57) ABSTRACT

An interactive television channel is described which includes a programming center, a master control center, a distribution center such as a satellite broadcast center or cable head end, a customer site, and a commerce server. A broadcast signal is received via a “set-top box” such as a cable connection or a DBS integrated receiver-decoder at the customer site, which supplies video and audio signals to a conventional television receiver. When a viewer tunes to the interactive music channel, the television receiver screen displays a window in which content, such as a music video, is playing. Also displayed on the screen is a surrounding matte comprising a high-quality professionally produced graphic identifying the channel. In addition, the screen displays one or more “sensitive” areas to which the viewer may direct a cursor using a remote control. By directing the cursor to a sensitive area, the area becomes highlighted. By pressing the SELECT button on the TV remote when a sensitive area is highlighted, the viewer can activate additional screen displays providing related features, such as music news, or menus allowing the viewer to immediately purchase products such as CD's, cassette tapes, etc. If the viewer follows the menu to execute a purchase, the requested purchase transaction is supplied via a backchannel (such as a telephone line) to a commerce server which charges the viewer's credit card and enters an order for the selected product to be shipped to the viewer.

### BACKGROUND OF THE INVENTION

1. Field of the Invention

The invention relates generally to interactive television and, more particularly, to interactive television for promoting and selling products.

2. Description of the Related Art

Promotion, distribution, and sales of a variety of products are undergoing fundamental changes as a result of the advent of new technology, such as direct broadcast satellites and the Internet. For example, ever larger numbers of customers are choosing to select and purchase products such as recorded music tapes and CDs online, over the Internet. Music videos transmitted over cable and satellite channels such as MTV are supplementing radio airplay as the primary means of promoting music. However, apparatus and methods currently available for purchasing music do not provide the degree of convenience that consumers desire. Correspondingly, sellers of recorded music also do not currently have available to them an acceptable way to enable customers to indulge in impulse purchases when the customer first becomes aware of a new artist or song. It is therefore desirable to provide methods and apparatus to enable sellers to widely promote products such as new recorded music albums to customers and provide customers with a quick and convenient way to purchase such products.

### SUMMARY OF THE INVENTION

Additional features and advantages of the invention will be set forth in the description which follows, and in part will be apparent from the description, or may be learned by practice of the invention, as pointed out in the written description and claims hereof, as well as the appended drawings.

In accordance with the purpose of the invention as embodied and broadly described, a method for generating a datastream at a control location for implementing an interactive television application at a viewer location comprises receiving a first video signal constituting a primary image, receiving a second video signal constituting a secondary image, combining the first and second video signals to form a broadcast video signal representing a composite of the primary and secondary images, generating instructions to form an interactive television client application program which defines a specified portion of the composite image as a location for a sensitive area, combining the instructions with the broadcast video signal, and outputting the combined signal for transmission to a customer location.

### BRIEF DESCRIPTION OF THE DRAWINGS

The accompanying drawings, which are incorporated in and constitute a part of this specification, illustrate embodiments of the invention.

In the drawings:

FIG. 1 is a block diagram showing a system for implementing an interactive music channel consistent with the present invention;

FIG. 2 is a block diagram of the set-top box of FIG. 1;

FIG. 3 shows an initial “splash” screen which may be displayed in the interactive music channel of FIG. 1;

FIG. 4 shows an opening interactive screen which may be displayed in the interactive music channel of FIG. 1;

FIG. 5 shows a supplemental, or “enhanced” screen consisting of a purchase info screen which may be displayed in the interactive music channel of FIG. 1;

FIG. 6 shows an enhanced screen consisting of a second purchase info screen which may be displayed in the interactive music channel of FIG. 1;

FIG. 7 shows an enhanced screen consisting of a third purchase info screen which may be displayed in the interactive music channel of FIG. 1;

FIG. 8 shows an enhanced screen consisting of a fourth purchase info screen which may be displayed in the interactive music channel of FIG. 1;

FIG. 9 shows an enhanced screen consisting of a fifth purchase info screen which may be displayed in the interactive music channel of FIG. 1;

FIG. 10 shows an enhanced screen consisting of a sixth purchase info screen which may be displayed in the interactive music channel of FIG. 1;

FIG. 11 shows an enhanced screen consisting of a seventh purchase info screen which may be displayed in the interactive music channel of FIG. 1;

FIG. 12 shows an enhanced screen consisting of a shipping info screen which may be displayed in the interactive music channel of FIG. 1;

FIG. 13 shows an enhanced screen consisting of an eighth purchase info screen which may be displayed in the interactive music channel of FIG. 1;

FIG. 14 shows an enhanced screen consisting of an order confirmation screen which may be displayed in the interactive music channel of FIG. 1;

FIG. 15 shows an enhanced screen consisting of a news screen which may be displayed in the interactive music channel of FIG. 1;

FIG. 16 shows an enhanced screen consisting of a second news screen which may be displayed in the interactive music channel of FIG. 1;

FIG. 17 shows an enhanced screen consisting of an ad screen which may be displayed in the interactive music channel of FIG. 1; and

FIG. 18 shows one example of the flow of catalog information in the system of FIG. 1.

### DETAILED DESCRIPTION

An embodiment consistent with the present invention is implemented in an interactive music channel broadcast over a communications channel, such as a direct broadcast satellite (DBS). Other embodiments consistent with the invention may be implemented as channels broadcast over other communications channels, such as a CATV channel or the Internet.

In the described embodiment, the broadcast is received via a conventional DBS dish antenna and a DBS integrated receiver-decoder (“set-top box”) supplying video and audio signals to a conventional television receiver. When a viewer tunes to the interactive music channel, the television receiver screen displays a window in which content, such as a music video, is playing. Also displayed on the screen is a surrounding matte comprising a high-quality professionally produced graphic identifying the channel. In addition, the screen displays one or more “sensitive” areas to which the viewer may direct a cursor using a remote control. By directing the cursor to a sensitive area, the area becomes highlighted. By pressing the SELECT button on the TV remote when a sensitive area is highlighted, the viewer can activate additional screen displays providing related features, such as music news, or menus allowing the viewer to immediately purchase products such as CD's, cassette tapes, etc. If the viewer follows the menu to execute a purchase, the requested purchase transaction is supplied via a backchannel (such as a telephone line) to a commerce server which charges the viewer's credit card and enters an order for the selected product to be shipped to the viewer.

A feature of the datastream which supports this capability is the catalog. In certain embodiments, a catalog is distributed via broadcast methods (e.g. digital broadcast satellite or digital cable). The catalog provides consumers with information about available commerce opportunities. Distribution of the catalog can be achieved by various methods. For example, a catalog may be constantly broadcast to viewers and, when needed, loaded into short-term storage (e.g. random access memory) for processing. Alternatively, a catalog may be broadcast and stored on a long-term storage device (e.g. hard drive) at the viewer location so that the stored catalog is available for processing when needed and there is no need to await catalog entries to be broadcast.

Referring to the Figures, in which like reference characters refer to the same or corresponding elements, FIG. I shows a system 10 for implementing an interactive music channel consistent with the present invention.

System 10 includes a programming center 12, a master control center 14, a satellite broadcast center 16, a customer site 18, and a commerce center 20. Centers 12, 14, 16, and 20 may be at the same physical location or may be situated at separate locations anywhere in the world. The customer site 18 is typically a viewer watching the interactive music channel on a television receiver 22 in the viewer's home. Of course, the system would normally include thousands or even millions of separate customer sites 18. One or more customer sites may also be located in public places, such as retail stores or sales kiosks.

Programming personnel at programming center 12 generate a program playlist 26 consisting of an identification of specific content to be broadcast, including the exact time at which each item will be broadcast. Broadcast items on the program playlist may include items such as music videos, recorded or live concerts, talk shows, etc. Other personnel at programming center 12 generate a trigger playlist 28 consisting of a series of commands to activate various interactive features, and the exact times at which such features will be activated. A more complete description of interactive features corresponding to specific triggers will be provided below. The program playlist and trigger playlist are supplied to a list management system 24, which may comprise a personal computer.

Programming center 12 further includes a graphics/content server 30 which generates graphic and text elements, some to be viewed as overlays when certain features are selected by the viewer and others to be viewed as a video component. The output of list management system 24 and graphic/content server 30 is in the form of electronic files which are supplied to a network 32 for transmission to master control center 14. Network 32 may be a public network, such as the Internet, or a private dial-up connection or dedicated connection to master control center 14. Other transmission methods may be used, such as physical delivery of a computer-readable medium.

Master control center 14 may be located at facilities of a third party vendor such as, for example, Crawford Communications of Atlanta, Ga. or Compact Video Services of Burbank, Calif. Alternately, the functions of master control center 14 may be performed by the operator of interactive music channel 10.

Master control center 14 includes a video switcher 40 which combines desired video sources forming the content to be broadcast over the interactive music channel. Video sources may include one or more video servers 42, video tape decks 44, and ad graphic/still stores 46. Optionally, interactive music channel 10 may include the capability to transmit live video, such as, for example, a concert, via an optical fiber video input line 48. Video input line 48 is typically supplied from programming center 12, but may be supplied from anywhere.

Master control center 14 further includes a video automation unit 50 which receives program playlist data as input. This input data is the same data as generated at the program playlist 26 of programming center 12. It may be supplied via an electronic connection over network 32 or, alternately, on a computer-readable medium, such as a floppy disk. Video automation unit 50 also receives a time signal input from a network clock 52. Video automation unit 50 generates control signals at times specified by the program playlist input and supplies these control signals to input sources 42-46 and to video switcher 40. Accordingly, video switcher 40 selects inputs specified by data in the program playlist, and the appropriate video sources 42-46 are then activated by control signals from video automation unit 50. Video automation unit 50 may first generate a LOAD command if, for example, a specific tape must first be loaded into deck 44 before it is actuated. Video switcher 40 thus receives multiple video signals, such as a first signal constituting a primary image and a second video signal constituting a secondary image, and combines them to form a broadcast video signal representing a composite of the primary and secondary images. Audio and video signals from the selected sources are then supplied by video switcher 40 to an MPEG encoder 54.

Master control center 14 also includes a content staging server 55 which receives graphics data via network 32 from graphics/content server 30. Content staging server 55 may also receive content generated at locations other than programming center 12 consisting of other types of data, such as catalog data.

Master control center 14 also includes a trigger server 56 which receives time signals from network clock 52 and trigger data from trigger playlist 28. Trigger data from playlist 28 may be received either electronically via network 32 or on a computer readable medium, such as a floppy disk. Trigger server 56 generates a plurality of types of trigger signals as specified by trigger playlist 28 at times also specified by trigger playlist 28. A more complete description of trigger signals will be provided below.

Master control center 14 also includes an interactive television content system 60 for implementing the interactive features of interactive music channel 10. Interactive television content system 60 comprises a computer system operating interactive television software, such as the Open Streamer system available from OpenTV of Mountain View, Calif. Interactive television content system 60 includes an application server 62 and a broadcast server 64.

Application server 62 receives graphics content from content staging server 55, as specified by control signals from application server 58. These control signals may be in the form of HTTP or FTP requests and may include specifications of one or more locations in the primary and/or secondary images which will become sensitive areas on a viewer's screen. Application server 62 and broadcast server 64 execute portions of an interactive television application server program to generate “STB” instructions to be executed as an interactive television client application program upon a set-top box (STB) 80 at customer location 18, including rendering the locations as sensitive areas. The interactive television server program on application server 62 also generates graphics data from content staging server 58 and supplies it, along with the STB instructions, to broadcast server 64. Broadcast server 64 combines the graphics data and STB instructions with MPEG-encoded audio and video data from MPEG encoder 54 and supplies a composite signal comprising a multiplexed MPEG data stream 65 to satellite broadcast center 16 by an appropriate communication channel, such as a fiber optic line or a satellite link. Alternatively, audio and video data may be transmitted to satellite broadcast center 16 over a channel separate from the channel carrying STB instructions.

Satellite broadcast center 16 may be operated by a direct broadcast satellite supplier such as, for example, Echostar, Inc. of Cheyenne, Wyoming. The MPEG data stream from interactive television content system 60 is then multiplexed at satellite broadcast center 16 with data streams from other DBS channels and transmitted as a broadcast signal by a ground station at satellite broadcast center 16 to a direct broadcast satellite (not shown) located, for example, in geosynchronous orbit above the earth.

Broadcast signals from the satellite are received at customer location 18 on a conventional DBS dish antenna 81 and supplied to set-top box 80 consisting of an integrated receiver-decoder (IRD) and a processor supporting an interactive television runtime environment such as, for example, the EN2 Operating System of OpenTV, Inc. When a viewer at customer location 18 desires to view the interactive music channel, the viewer operates set-top box 80, typically via a remote control, to cause set-top box 80 to tune in a well-known manner to the desired satellite frequency and demultiplex the received signal to extract data of the interactive music channel. The extracted data includes instructions and data forming the set-top box interactive television client application program generated by application server 62. Such instructions and data are stored by set-top box 80 and executed by a processor therein to perform interactive features to be described below in greater detail. The audio and video signals of the interactive music channel are then supplied to television 22 for display at customer location 18.

Alternatively, broadcast signals from the satellite may be received at a CATV head end for distribution to individual viewers. STB 80 would constitute a cable STB in this alternative.

The viewer operates his remote control to cause set-top box 80 to execute desired interactive features. Such features may include, for example, purchase instructions to purchase a desired product. These instructions are supplied by set-top box 80 to a backchannel modem 82. Modem 82 may be either external to set-top box 80 or located therein, and may be connected to a backchannel such as, for example, the Internet or a dial-up telephone line at customer location 18. Modem 82 then transmits purchase instructions, including, for example, credit card billing information, in a well known manner to commerce center 20. In certain applications, it may be desirable to supply credit card information to commerce server 92 via sources other than STB 80. Purchase instructions from modem 82 are received via a modem stack 90 and supplied to a commerce server 92. Commerce server 92 may be, for example, a standard server such as an IBM RISC 6000 server executing commerce software such as, for example, Web Logix obtained from the BEA Corporation. Commerce server 92 then generates shipping instructions to cause the desired purchased product to be shipped to customer location 18.

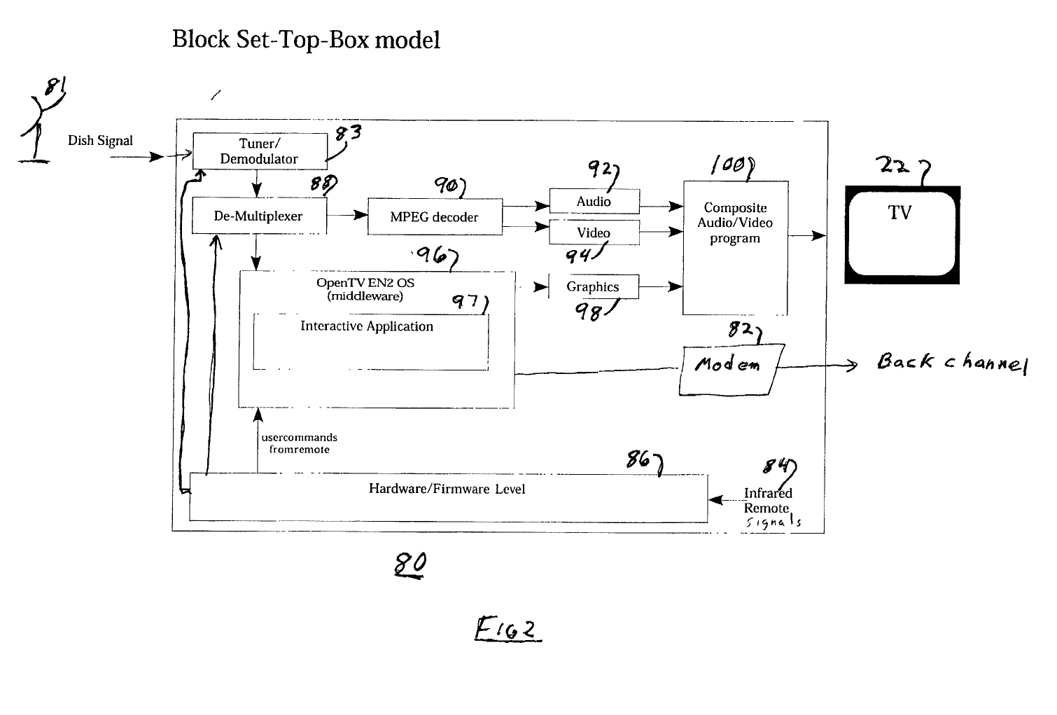

Referring now to FIG. 2, set-top box 80 is shown in greater detail. Set-top box 80 is an integrated receiver-decoder plus processor which executes an interactive television application. For example, set-top box 80 may be an Echostar model 3900 or 4900 executing the OpenTV EN2 Operating System and runtime environment. As shown in FIG. 2, set-top box 80 includes a tuner/demodulator 83 which receives an RF signal from DBS dish antenna 81. A viewer activates a remote control unit to generate signals such as, for example, infrared remote signals 84 which are supplied to a processor 86 to generate control signals to tuner/demodulator 83. Tuner/demodulator 83 tunes to the RF frequency of the selected channel, demodulates the signals therefrom, and supplies the demodulated signals to a demultiplexer 88.

A signal supplied from demodulator 83 typically includes data from a plurality of channels. Thus, infrared remote signals 84 cause processor 86 to generate appropriate control signals to demultiplexer 88 to extract data for only the desired channel. This extracted data includes MPEG audio and video data which is supplied to an MPEG decoder 90. MPEG decoder 90 decompresses the encoded audio and video digital signals and respectively supplies them to audio and video circuits 92 and 94 for conversion to analog signals. In certain applications, the decompressed audio and video signals may remain in digital format.

Demultiplexer 88 also extracts set-top box instructions and data for the desired channel from the multiplexed signal. The set-top box instructions and data are supplied to the interactive television runtime environment to cause set-top box 80 to execute the interactive television client application program 97. Certain data may be cached in STB 80. Interactive television client application program 97 generates appropriate digital video signals which may be supplied to a graphics circuit 98 to generate analog or digital graphics signals. The graphics signals from circuit 98 may be combined with audio and video signals from circuits 92 and 94 in a circuit 100 to form a composite television signal including audio, video, and graphics features. This composite signal is then supplied to television 22 for display. In certain applications, some or all signals may be supplied to television 22 in digital format.

A viewer may supply commands via the STB remote control to cause areas on television 22 to be highlighted by interactive television client application program 97. When the viewer then presses a SELECT button on the remote control, additional information may be displayed on television 22 or other interactive features may be executed, such as purchase requests. Such interactive features will be described below in greater detail.

Purchase requests, as recognized by interactive television client application 97, cause generation of purchase request signals which are supplied to modem 82. Modem 82 then transmits the purchase requests over a backchannel, such as a dial-up telephone connection or an internet connection.

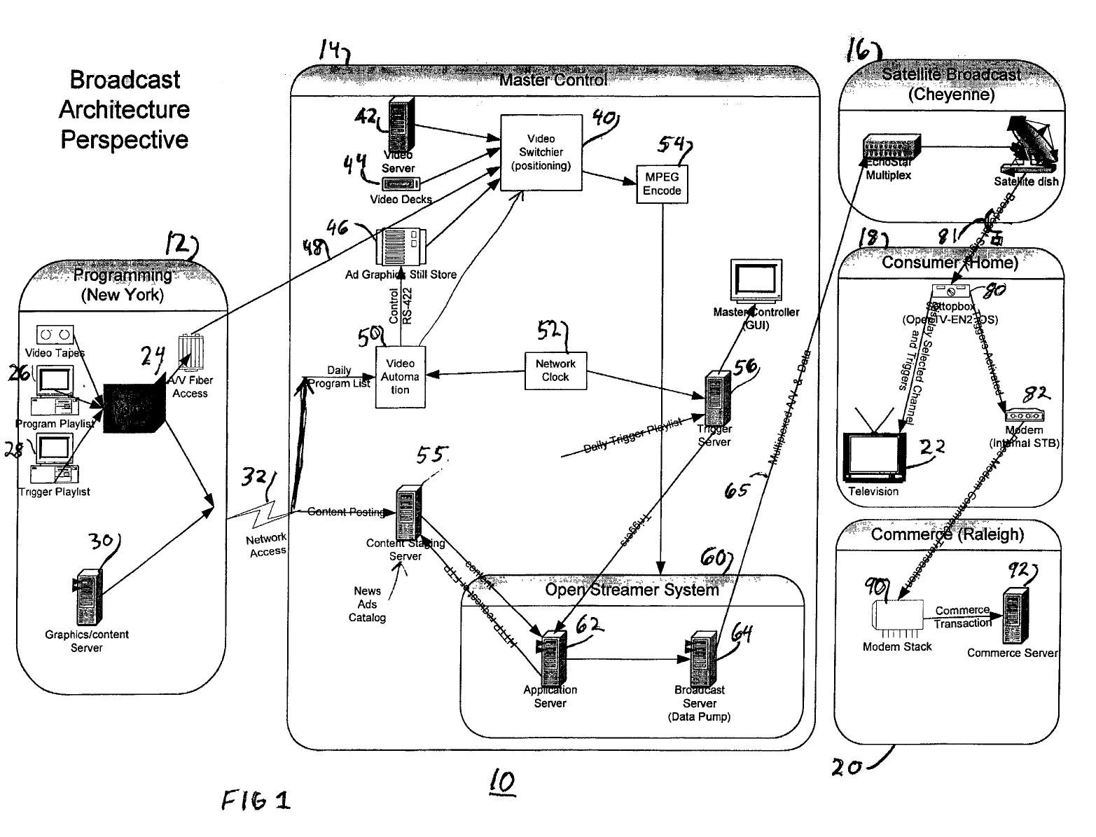

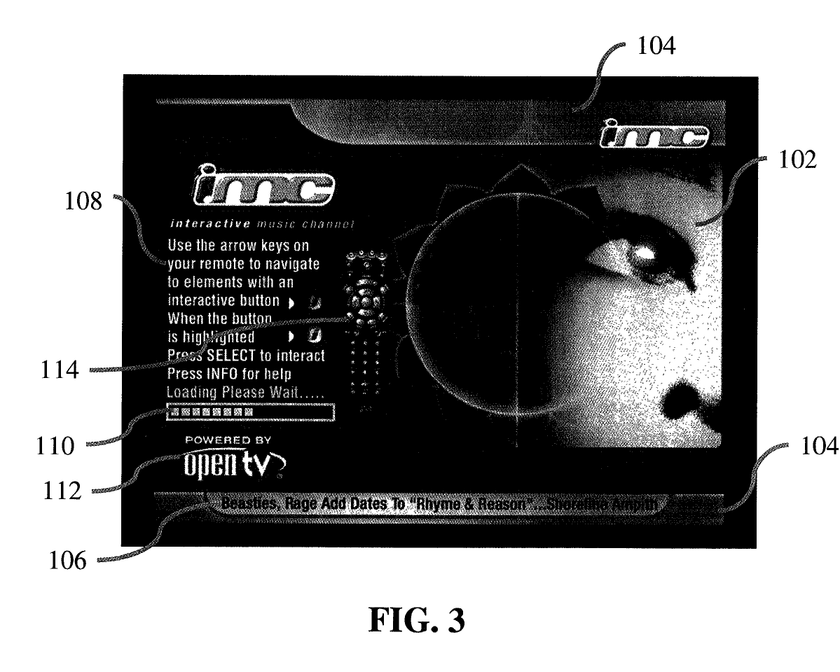

FIG. 3 shows an initial “splash” screen which may be displayed when a viewer first tunes to the interactive music channel of system 10. The splash screen typically includes a plurality of areas each having different characteristics. First, the splash screen may include a primary image having a video display area 102 in which is displayed the video, such as full-motion video, from the source selected by video switcher 40 (FIG. 1). The video will begin to display in area 102 and the associated audio will begin to play from the audio portions of television 22 as soon as MPEG decoder 90 (FIG. 2) generates the corresponding audio and video signals.

The splash screen of this embodiment also includes a secondary image having a matte frame area 104 comprising a border area having a pleasing color and appearance. Area 104 was initially generated by professional graphics personnel, processed by graphics/content server 30 (FIG. 1), combined in broadcast server 64 with the first video signal constituting the primary image, and transmitted to STB 80. The display screen may also include additional features generated by graphics/content server 30, such as a scrolling “news wire” type display 106 providing continuously running brief news items.

The splash screen of FIG. 3 may also include an interactive area 108 which contains an initial welcome screen including instructions for operating the interactive features of the interactive music channel. The splash screen of FIG. 3 is displayed during the period while instructions of the interactive television client applications program 97 are being loaded into set-top box 80 (FIG. 2) from the received data stream. The progress of the loading operation is indicated by a moving load indicator 110 of conventional design.

The splash screen of FIG. 3 also includes an interactive advertising area 112. Area 112 initially includes the logo of the provider of the interactive television application program, until program 97 begins to execute. The location and appearance of interactive ad area 112 is determined and specified by personnel in programming center 12. This specification is received by master control center and overlaid upon the primary or recording image. Also, instructions are generated in master control center 14 to render a sensitive area on a viewers screen at the specified location.

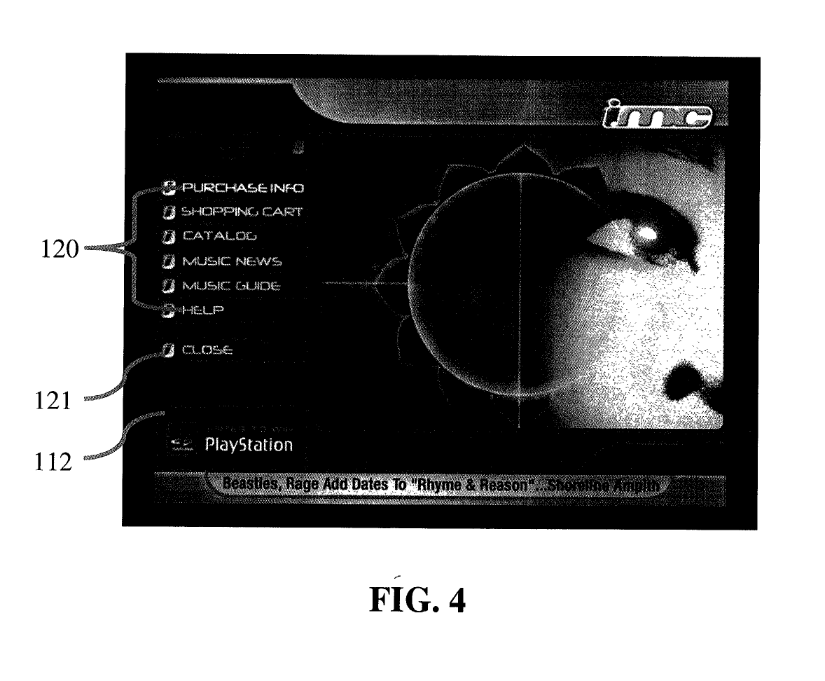

When the interactive television client application program 97 has been successfully loaded and begins to execute, it causes the splash screen of FIG. 3 to change to an opening interactive screen, such as shown in FIG. 4. Area 102 continues to display the received video being supplied through video switcher 40 (FIG. 1). Similarly, matte display 104 continues to be displayed. In fact, matte display 104 may be continuously displayed at all times that the viewer is tuned to the interactive music channel. This provides a consistent, readily recognizable brand identification.

Interactive area 108 now contains an interactive menu as shown in FIG. 4. The menu includes a plurality of menu items 120 such as “PURCHASE INFO,” “SHOPPING CART,” “CATALOG,” “MUSIC NEWS,” “MUSIC GUIDE,” “HELP,” and “CLOSE,”. Each menu item also includes an icon 121 consisting of a stylized “i” indicating to the viewer that the menu item is an interactive, or “sensitive”, area. In the initial interactive screen of FIG. 4, the “PURCHASE INFO” menu item and its corresponding interactive icon 121 are highlighted, for example, displayed in bright yellow. The remaining menu items and their associated interactive icons 121 are of a uniform, less distinctive color to somewhat blend into the background of the screen. This indicates to the viewer that the “PURCHASE INFO” menu item is “active.”

The OpenTV logo in interactive ad area 112 of FIG. 3 has been replaced by an actual interactive ad, as shown in FIG. 4. Operation of the interactive ad of area 112 will be described below.

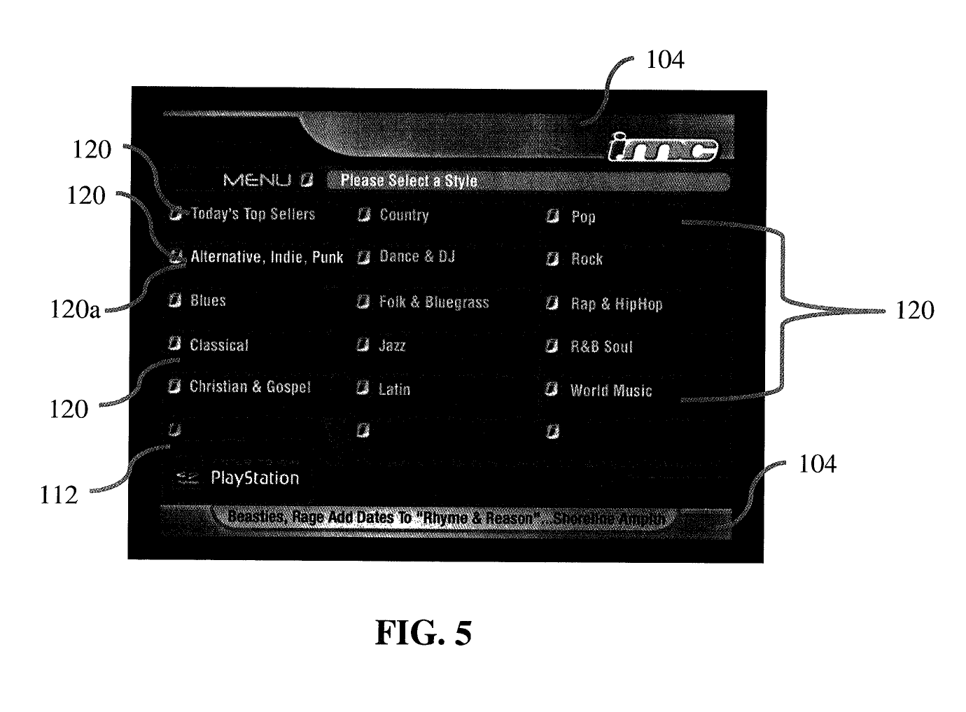

As mentioned above, the “PURCHASE INFO” menu item is currently highlighted, indicating to the viewer that it is active. If the viewer presses the SELECT key on his remote control while the “PURCHASE INFO” menu item is highlighted, a supplemental, or “enhanced” screen consisting of an initial purchase screen is displayed, as shown in FIG. 5. Note that the video area 102 no longer visible and interactive area 108 has enlarged to occupy a much greater portion of the display screen shown in FIG. 5. Matte area 104 and interactive ad area 112 continue to be displayed.

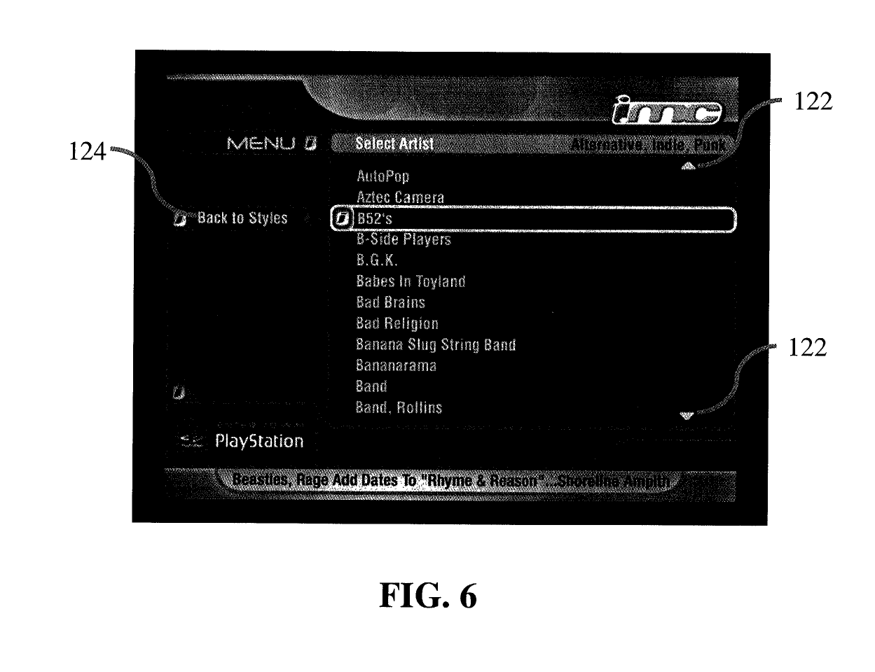

An instruction is provided to the viewer in FIG. 5 as a distinctive yellow instruction “PLEASE SELECT A STYLE.” The initial purchase info screen of FIG. 5 also includes a plurality of interactive areas 120 each including an interactive icon 121 and a listing of a style of music. The viewer may navigate through the screen of FIG. 5 by pressing the arrow keys on his remote control to selectively cause individual interactive areas to become highlighted. For example, area 120a specifying a style of “Alternative, Indie, Punk” is highlighted. If the viewer then presses the SELECT key on his remote control while area 120a is highlighted, interactive television client application program 97 causes an enhanced screen consisting of a second purchase info screen to be displayed, shown in FIG. 6, in which an alphabetical list of artists of the Alternative, Indie, Punk style is displayed. This list may be generated from the cached data. The viewer may navigate up and down through the displayed list, causing individual artist names to be highlighted. Scroll icons 122 are provided to inform the viewer that additional artists not currently displayed in the window may be viewed by continued use of the up and down arrow keys on the remote control. A menu backtracking area 124 is also displayed, permitting the viewer to highlight the area, press the SELECT key, and return to the Styles screen of FIG. 5.

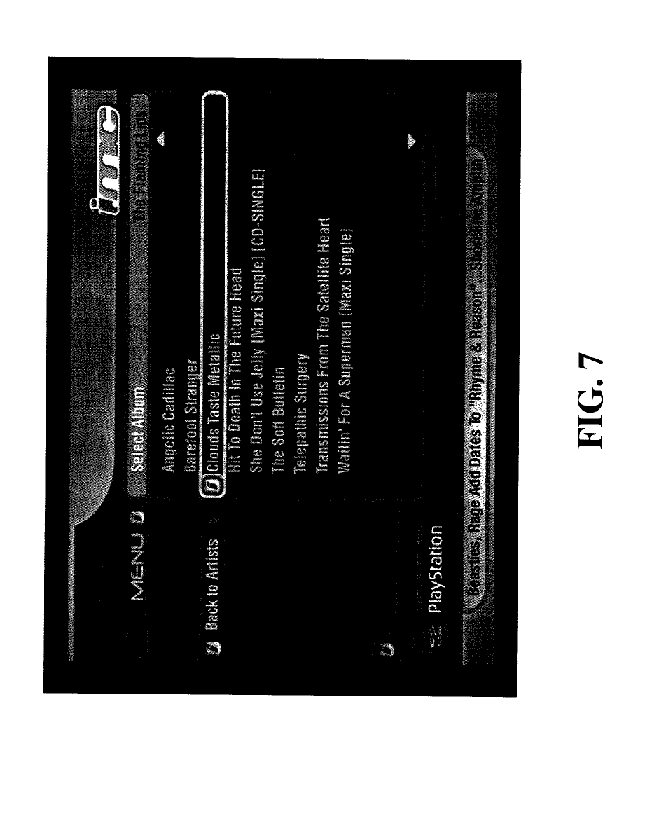

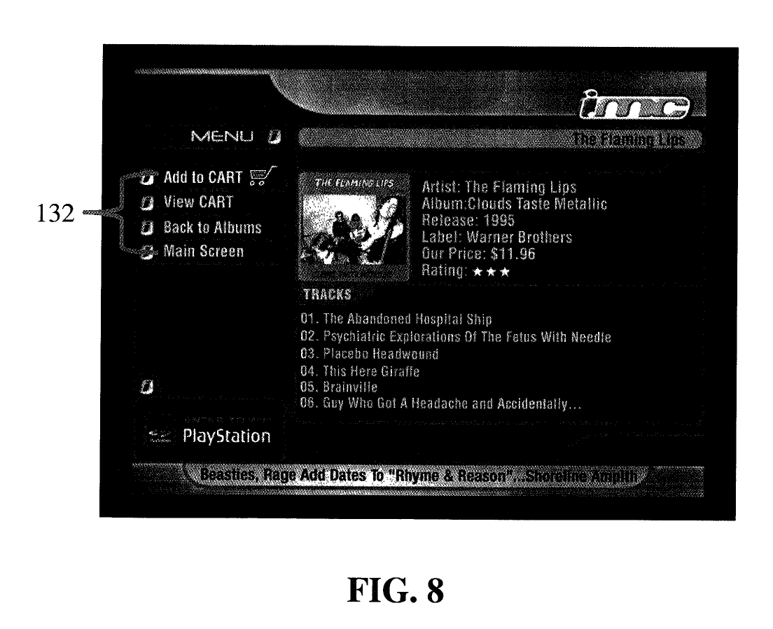

Assume that the viewer has scrolled to display additional artists, including The Flaming Lips. When the viewer navigates to this artist name, highlighting the name, and then presses the SELECT key, interactive television application program 97 causes a third purchase info screen to be displayed, as shown in FIG. 7. This screen lists the titles of albums produced by The Flaming Lips which are available for purchase through the interactive music channel. The viewer has the option to scroll through the list of available album titles, to highlight a desired title. For example, FIG. 7 shows the album title Clouds Taste Metallic as being highlighted, including a highlighted interactive icon 121. If the viewer then presses the SELECT key while Clouds Taste Metallic is highlighted, interactive television client application program 97 causes the next purchase info screen to be displayed, as shown in FIG. 8.

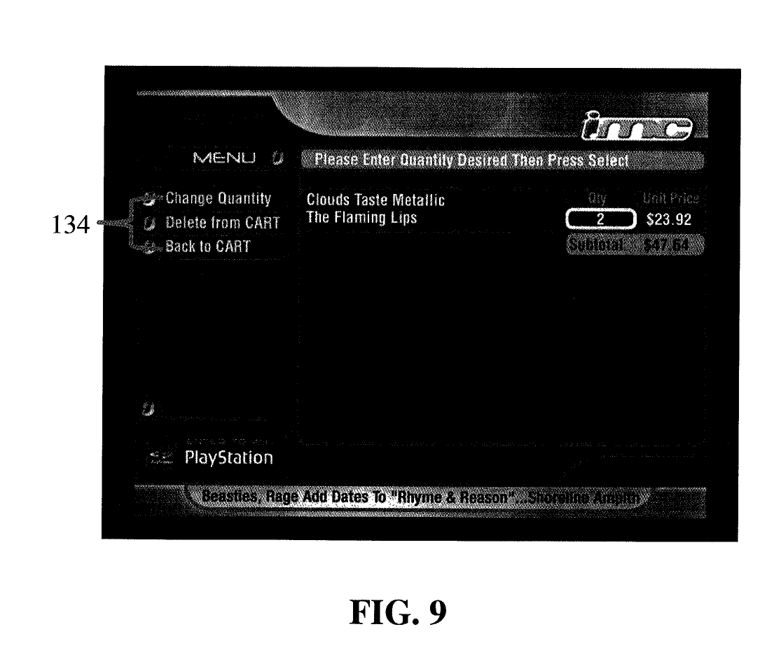

FIG. 8 includes detailed information about the selected album title, including release date, label, price, and track titles, as well as a graphic of cover art. As shown in FIG. 8, the screen also includes several navigation and purchase areas 132, including “ADD TO CART,” “VIEW CART,” “BACK TO ALBUMS,” and “MAIN SCREEN.” If the viewer operates his remote control to highlight the “ADD TO CART” interactive area, and then presses the SELECT key, the viewer has indicated a tentative intention to purchase the album. Interactive television client application 97 then causes the screen of FIG. 9 to be displayed, prompting the viewer to enter the quantity of the selected album desired. The viewer does this by using the number keys of his remote control. Interactive television client application 97 then causes data representing the tentative purchase decision to be stored in memory of STB 80 in a purchase buffer.

The information specifying various albums for purchase, as described above, is termed “catalog information.” This information is typically generated by commerce center 20 and supplied to content staging server 58 (FIG. 1). As has been described above, the catalog information is processed into a hierarchical structure by content staging server 55 and incorporated into a tree-like series of supplemental screens generated by interactive television client application 97. The structure and delivery of the catalog information is described below.

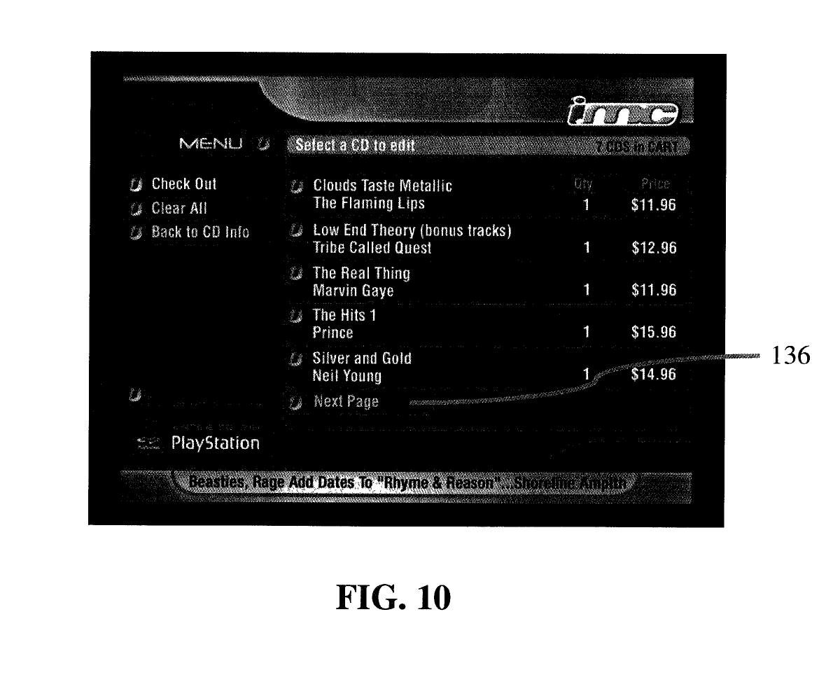

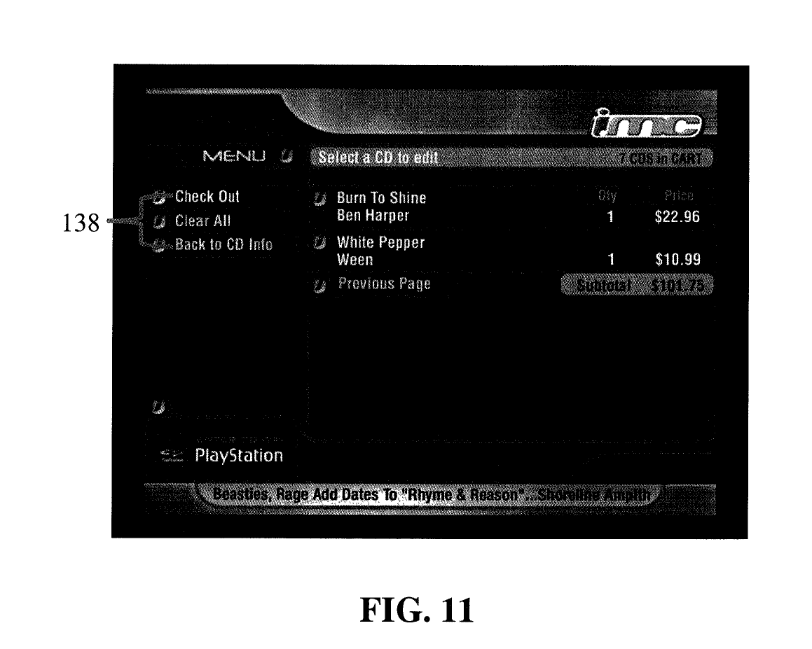

As shown in FIG. 9, the viewer has tentatively requested to purchase two copies of the selected album title Clouds Taste Metallic. The viewer then has several options, as indicated by interactive areas 134 of FIG. 9. If the viewer decides to change the number of copies desired, he may press the CHANGE QUANTITY icon to allow a change, for example, to a quantity of one, and then select the item “BACK TO CART,” causing the interactive television client application program 97 to display a first page of the albums tentatively selected for purchase by the viewer shown in FIG. 10. As indicated in FIG. 10, by way of a “NEXT PAGE” area 136, the list of albums in his “shopping cart,” extends over more than one page. By selecting the area 136, the viewer may view the next page of albums tentatively listed for purchase, FIG. 11, including the subtotal of prices for all albums tentatively selected for purchase.

At this point, the viewer has several choices as indicated by interactive areas 138. Specifically, the viewer may “check out” to confirm his purchases, select “CLEAR ALL” to erase all tentatively purchased album titles from his shopping cart, that is, erase all data from the purchase buffer, or select “BACK TO CD INFO” to view additional catalogue items and, perhaps, select additional albums for purchase.

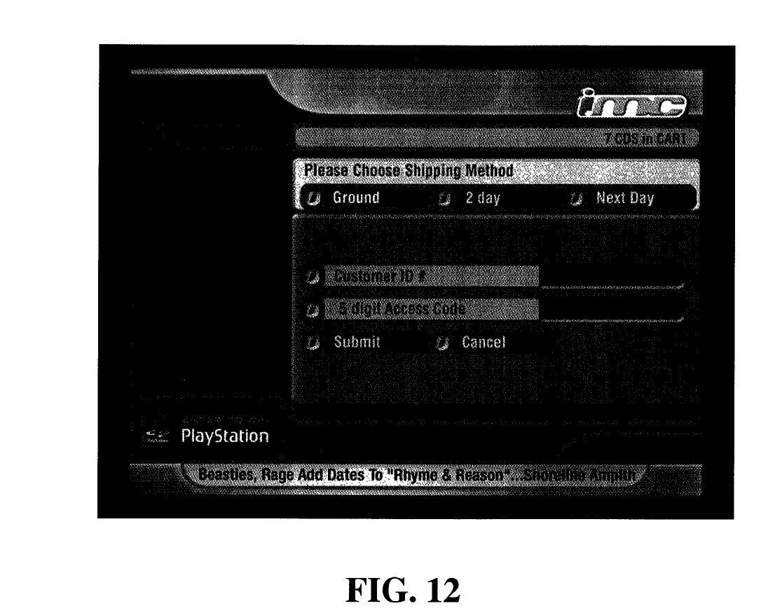

Assuming that the viewer selects “CHECK OUT,” interactive television client application program 97 causes the screen of FIG. 12 to be displayed, permitting the user to select a shipping method, enter a customer I.D. number, and enter a five-digit access code consisting of a password. After this information is entered, the viewer may either cancel the tentative order, or select the “submit” area to continue the purchase process.

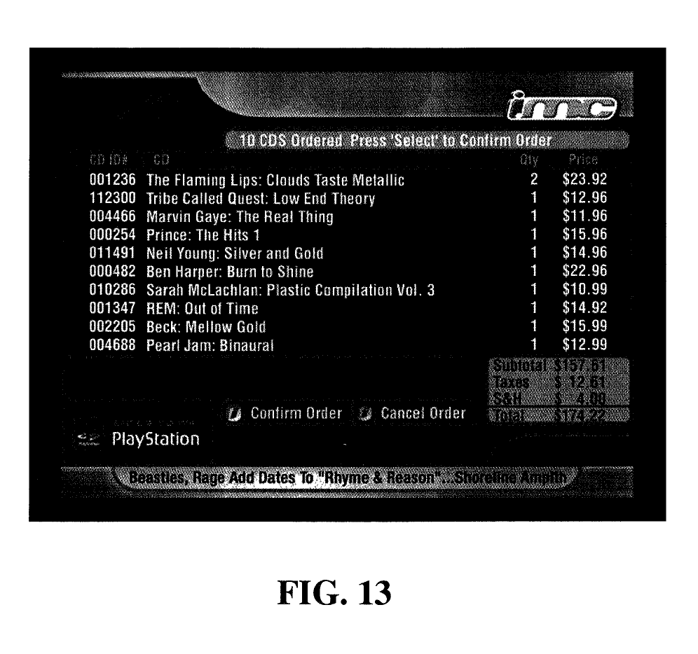

Assuming that the viewer selected the “submit” area, interactive television client application program 97 causes the screen of FIG. 13 to be displayed, listing all tentatively selected album titles, the individual purchase prices, the subtotal purchase price, taxes, shipping and handling charge, and the total amount of the purchase. At this point, the viewer may either cancel the order or confirm the order, by selecting the appropriate interactive area.

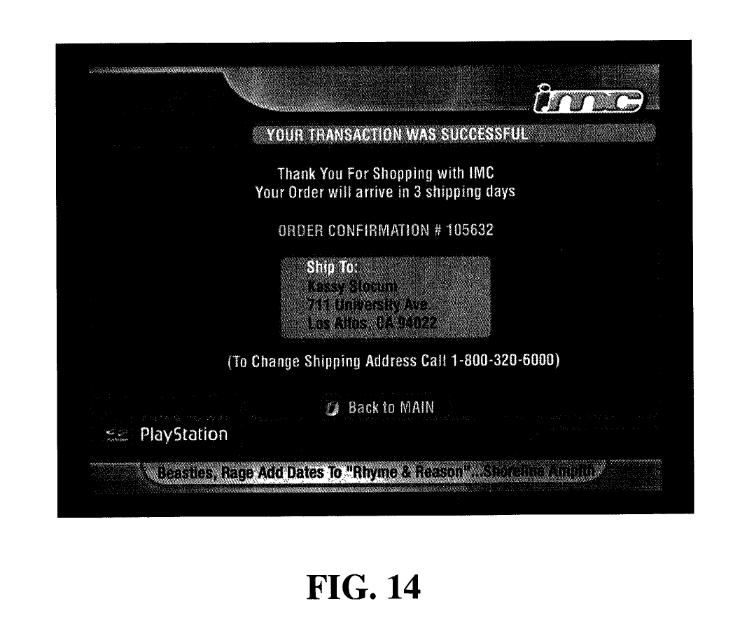

Assuming that the viewer selected the “confirm order” area, interactive television client application program 97 generates a purchase transaction signal from data stored in the purchase buffer, stores it in a queue in STB 80, generates a confirmation number, and displays an order confirmation screen as shown in FIG. 14. The confirmation screen displays the order confirmation number and shipping information, as well as a telephone number to call if the shipping address must be changed. At a preset time, for example, 2:00 AM, STB 80 activates modem 82 and transmits all purchase signals in the queue to commerce center 20 via the backchannel. The purchase request signal is received via modem stack 90 and supplied as a commerce transaction to commerce server 92 where it is processed in a well-known manner to confirm credit information of the viewer and initiate a shipping operation to deliver the purchased albums to the billing address. Although it is possible to generate an interactive television client application program 97 which will permit the viewer to enter data, such as name, address, telephone number, credit card number, etc., it is preferable in some applications to permit the viewer to enter data via other means, such as a telephone call to the operator of the interactive music channel or by secure transaction over the internet. The operator of interactive music channel then supplies a customer I.D. number and access code to facilitate viewer purchases.

In certain applications, it may be desirable to provide a plurality of customer I.D. numbers, providing a separate number for each member of a household. The separate numbers may include a variety of permission levels. Interactive television client application program instructions generating sensitive areas for various purchase transactions and interactive ad displays may include category indicators corresponding to the various permission levels. Thus, a customer I.D. number having the highest permission level may initiate transactions for all types of purchases and interactive ad activities. Customer I.D. numbers having lower permission levels may be limited in the types of purchase transactions and ad activities. For example, certain purchase transactions involving large dollar amounts may not accept purchase requests from customer I.D. numbers with lower permission levels. Also, certain interactive ad activities may not accept activation by customer I.D. numbers representing children below a certain age.

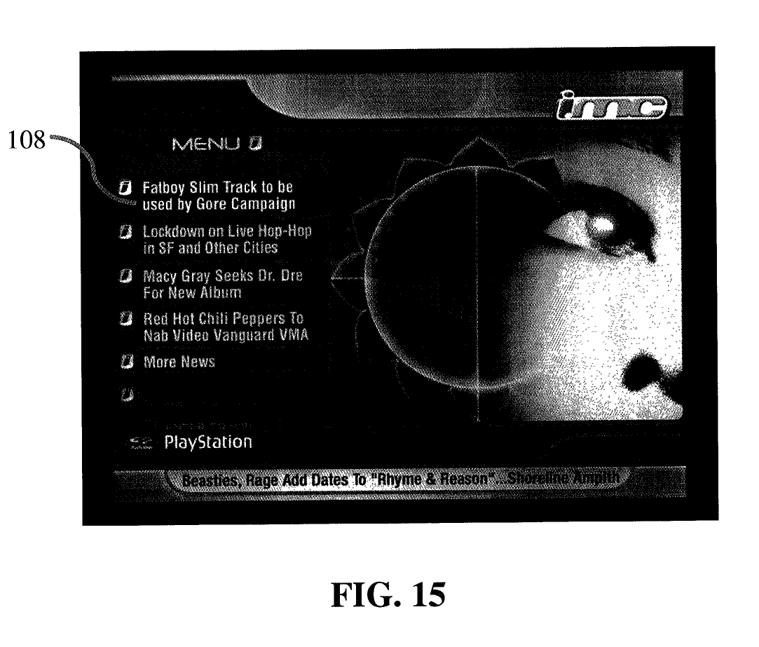

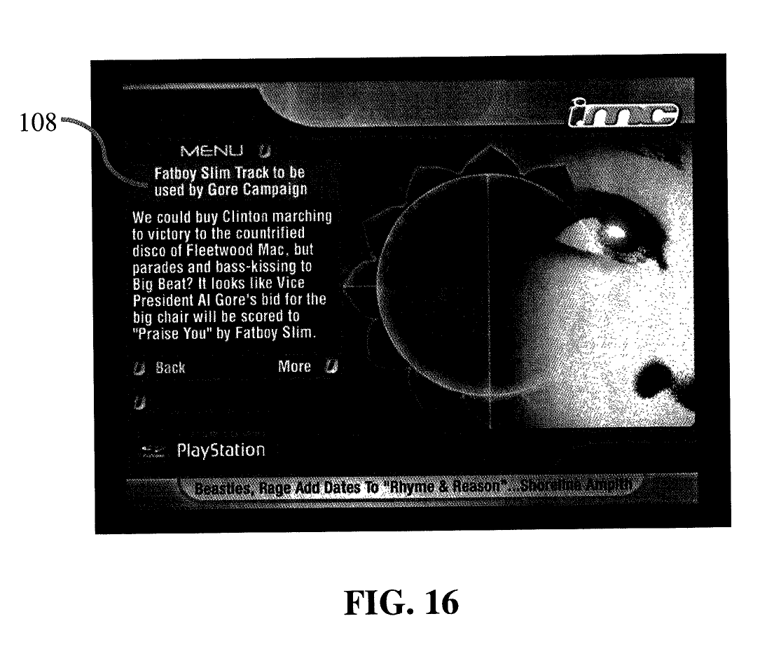

Referring back to FIG. 4, if the viewer highlights and selects the “MUSIC NEWS” area, interactive television client application program 97 causes a first news screen to be displayed, as shown in FIG. 15. Interactive area 108 includes a number of news “headlines” each accompanied by an interactive icon 121. The viewer may navigate through the displayed headlines, including a selection of more news to view additional headlines. Assuming that the viewer highlighted the first headline of interactive area 108 in FIG. 16, interactive television client application program 97 causes a second news screen to be displayed, as shown in FIG. 16. Interactive area 108 of FIG. 16 includes details of the selected news headline, including the ability to view additional details of the selected headline by selecting and activating the “MORE” interactive area.

As shown in FIGS. 4-16, the viewer has the opportunity to view an interactive ad as indicated at area 112. The location within the image and the rendering of area 112 as “sensitive” are implemented by specific instructions contained in interactive television client application program 97.

By highlighting and selecting interactive ad area 112, the viewer may display an advertisement purchased from the operator of the interactive music channel by a third party. The specific appearance of ad graphic presented in the sensitive area is determined by a video signal received by video switcher 40 (FIG. 1) and combined with the primary image to form a broadcast video signal. A first ad may be displayed for a specified period of time, and then replaced by a second ad, also received by switcher 40 and combined with a primary image to form a second broadcast video signal. Such ads may include promotions, such as the ability to win a premium by supplying the viewer's name and address, in a manner similar to the operation described above with respect to a purchase.

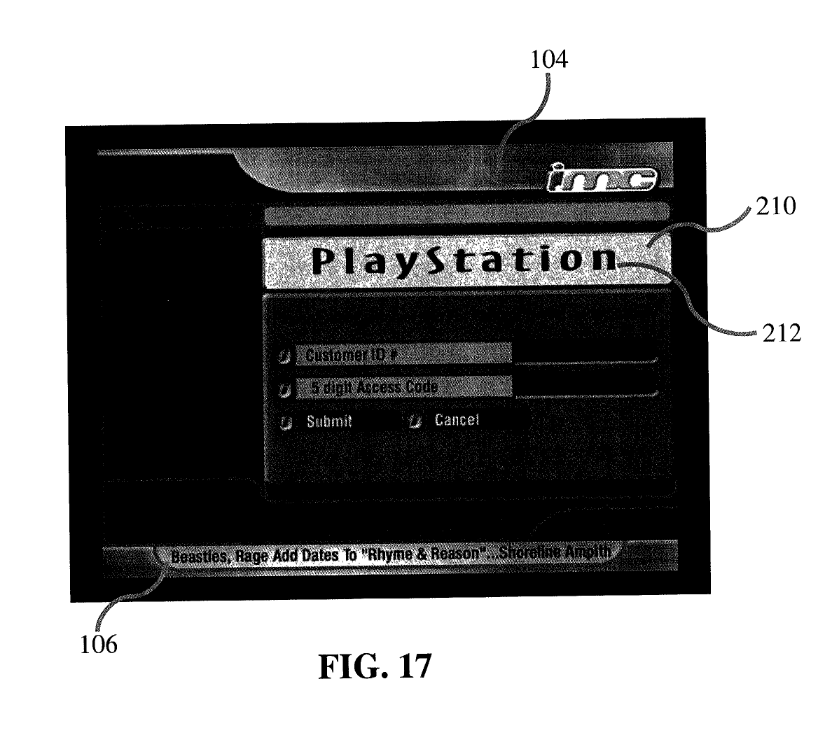

An exemplary ad is shown in the screen display of FIG. 17. As can be seen, the ad screen display includes matte frame area 104 and scrolling display 106, in the same manner as the other display screens described above. Thus, the system continues to provide an integrated look and feel for all screen displays generated by the system.

The ad screen of FIG. 17 also includes a background area 210 and an ad copy area 212, which are generated by program 97. The specific content of ad copy area 212 is typically specified by the third party who has purchased the right to have the specific ad displayed on the interactive music channel. Other features may be included in the ad display screen, such as data input screens to enable a viewer to supply his customer ID in return for a chance to enter a contest drawing or other promotion. The customer ID may be used to match up to specific customer name and address information to be supplied over the backchannel to the third party.

In general, triggers are used in master control center 14 to inform application server 62 of desired changes in the broadcast which require updates in the content being sent to the viewing audience receiving signals from satellite broadcast center 16. For example, a trigger may be used to inform application server 62 that a music video change is coming in a few seconds and that application server 62 needs to retrieve graphic/text information pertinent to the next music video (originally received from content staging server 58) and place this graphic/text information into a broadcast queue of broadcast server 64.

Similarly, a trigger signal may be generated by trigger server 56 to inform application server 62 in a frame-accurate manner that the actual program change has occurred. This action causes broadcast server 64 to insert a trigger into the data stream 65 which, when received by set-top box 80, will inform set-top box 80 that a currently displayed graphic is no longer needed and the new graphic should now be displayed in its place.

Triggers may also be used by programming staff at master control center 14 to generate set-top box instructions to command additional changes in the appearance of screens generated by set-top box 80 in all customer locations 18. For example, operator input by programming staff at master control center 14 may specify that the current signals from video switcher 40 will be displayed at the viewer location in a full screen mode so that video area 102 (FIG. 4) may expand to cover some or all of interactive area 108 and interactive ad area 112. Alternatively, the operator input may include a specific time in which the full screen mode will be initiated.

As described, broadcast audio and video selected by video switcher 40 is included in data stream 65 transmitted by direct broadcast satellite to set-top box 80. In addition, data stream 65 includes data representing text and graphics for use in implementing the above-described interactive features is supplied via content staging server 58 and interactive television content system 60. In an embodiment consistent with the present invention, studio production graphics are used to generate the data provided through interactive television content system 60. This data includes a plurality of selectable graphics content for transmission to and storage by set-top box 80. For example, graphics and text information comprising two interactive ads may be transmitted to and stored by set-top box 80. Following display of the OpenTV splash screen of FIG. 3, graphic data corresponding to the first interactive ad is retrieved from memory by interactive television client application program 97 and supplied through graphics circuit 98 and circuit 100 for display on television 22. When it is time to implement display of the second interactive ad in interactive ad area 112, a trigger is generated by trigger server 56 using information obtained from the trigger playlist. The trigger signal is supplied to application server 62 to generate set-top box instructions to be supplied from broadcast server 64 to data stream 65 for transmission via satellite broadcast center 16 to set-top box 80. Upon receipt of the instructions, interactive television client application program 97 retrieves graphic data corresponding to the second interactive ad and displays it in interactive ad area 112 of subsequent display screens.

Operation of trigger signals both in interactive television content system 60 and interactive television client application program 97 is determined by specifics of the interactive television application program. For example, details of the operation of trigger signals in an embodiment consistent with the present invention are contained in documentation obtainable from OpenTV, Inc. of Mountain View, Calif.

It can be seen that execution of interactive television client application program 97 causes display of a first screen containing the primary and secondary images, namely, the motion video image in video display area 102 and the graphics images in matte frame area 104. Then, in response to viewer input, interactive television client application program 97 generates virtual channel displays comprising a plurality of secondary screens including the secondary video image in matte frame area 104.

The disclosed system and methods provide consumers with broad-based commerce and promotion experiences via interactive television without the requirement of high-speed or broadband Internet access at the user station. In certain embodiments, a catalog is blanket broadcast to the user station in such a manner as to constantly maintain the entire catalog in the broadcast carousel. Interactive television client application program at STB 80 recognizes a viewer request for commerce or shopping opportunity, STB 80 receives the broadcast catalog from the broadcast carousel and presents the catalog to the viewer. This embodiment is particularly useful for low-end STBs with no hard drive or high-speed/broadband Internet connections. This catalog provides a powerful shopping experience for viewers. For example, in a music related catalog, a consumer can search for music by genre (jazz, rock, blues, etc.) or by artist. In addition, the viewer can be notified of promotional offerings such as a sale on country music.

In other embodiments, the catalog is structured for accumulation on STBs which include a hard drive. In these embodiments, the catalog is structured at the broadcast origin, and broadcast in sections. Interactive television client application program at STB 80 recognizes a catalog section to be received and stored on the user station hard drive. The result is a very deep catalog providing an Internet-like commerce and promotional experience without the need for high-speed or broadband Internet connections. In this embodiment, the shopping experience is not only broader, but more functional. For example, the catalog can support delivery of digital products directly to STB 80. In this case, the catalog can indicate when goods are being broadcast. Further, the viewer can set preferences indicating which digital products in the catalog are preferred.

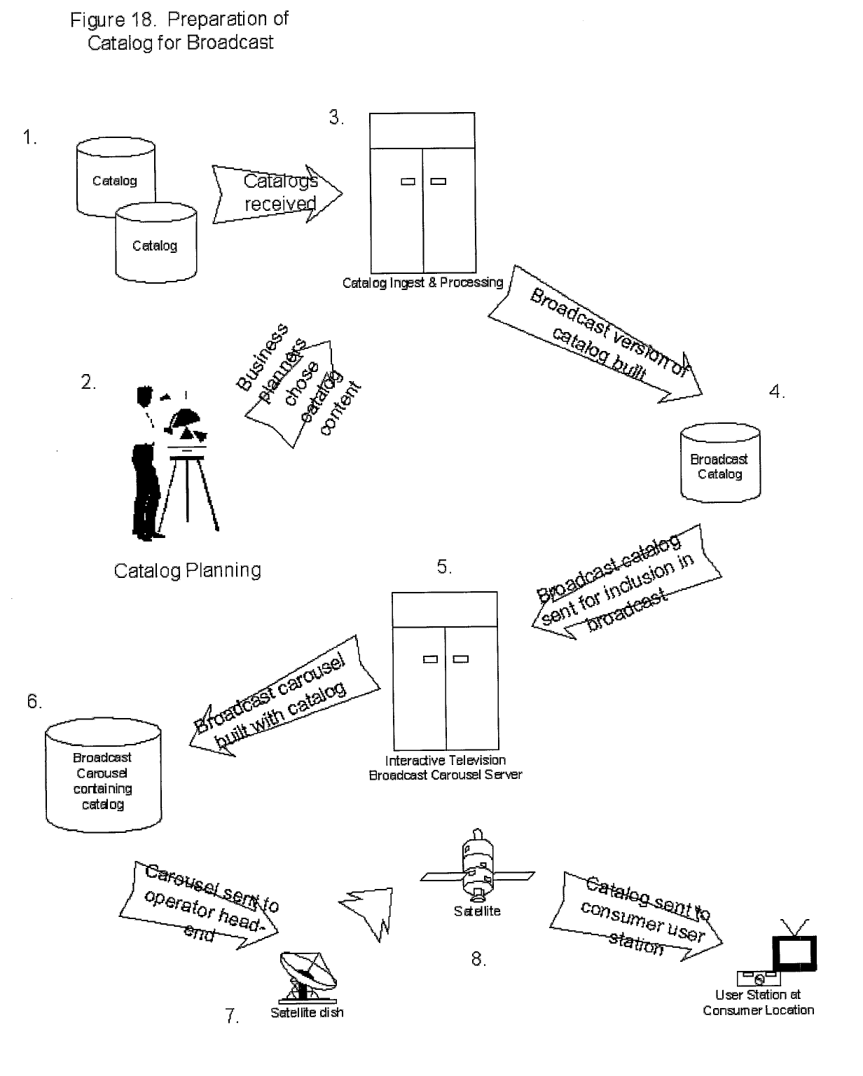

FIG. 18 shows catalog information flow for one embodiment of an interactive music channel. First, catalog content is received from vendors and stored at, for example, programming center 12. The operator of the interactive music channel chooses which portion of the available catalog content is desired to be offered to viewers. The selected portion becomes the broadcast catalog, which may be transmitted to content staging server 55 and on to interactive television system 60. There, the broadcast catalog is entered into a broadcast carousel and transmitted by broadcast server 64 to a communications channel for distribution to a viewer, for example, a CATV head end or satellite broadcast center 16. The broadcast catalog data is then sent to STB 80 at viewer location 18 for access during interactive television operations.

The disclosed system and methods also provide the ability to update music pricing at any time, for example on a daily, weekly or monthly basis, so that viewers can choose to order music at times when content providers offer pricing specials or incentives. This system also allows targeted advertising of specific products to persons of specific preferences. This advertising may be text, graphics or video on the customer's screen or portions of video /audio content.

It will be apparent to those skilled in the art that various modifications and variations can be made in the disclosed process and product without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for generating a datastream at a control location for implementing an interactive television application at a viewer location, comprising:
receiving a first video signal constituting a primary image;
receiving a second video signal constituting a secondary image; combining the first and second video signals to form a broadcast video signal representing a composite of the primary and secondary images;
receiving a specification of a predetermined location in at least one of the primary and secondary image as a specified portion of the composite image;
generating instructions to form an interactive television client application program which renders the specified portion of the composite image as a location for a sensitive area; and
outputting the instructions and the broadcast video signal for transmission to a customer location.

2. A method as recited in claim 1 comprising combining the instructions with the broadcast video signal and outputting the combined signal for transmission to a customer location.

3. A method as recited in claim 1 wherein the primary image comprises a moving video image.

4. A method as recited in claim 1 wherein the secondary image comprises a static video image.

5. A method as recited in claim 1 wherein the interactive television client application program includes instructions for causing a broadcast receiver to render the specified image portion as a first sensitive area to implement a desired interactive television operation.

6. A method as recited in claim 1 wherein the desired interactive television operation comprises displaying a supplemental screen.

7. A method as recited in claim 6 wherein the desired interactive television operation comprises displaying a plurality of supplemental screens containing catalog information.

8. A method as recited in claim 7 wherein the desired interactive television operation comprises receiving a viewer input to initiate a purchase transaction corresponding to at least a part of the catalog information.

9. A method as recited in claim 1 wherein the generated instructions cause a broadcast receiver to render the specified image portion as an initial display while the interactive television client application program is being loaded into a memory of a broadcast receiver, prior to rendering the specified image portion as a first sensitive area.

10. A method as recited in claim 1 wherein the secondary image comprises an interactive advertising area and the generated instructions cause a broadcast receiver to render the interactive advertising area as an initial display while the interactive television client application program is being loaded into a memory of a broadcast receiver, and the interactive television client application program subsequently renders the interactive advertising area as a second sensitive area.

11. A method for broadcasting an interactive television channel, comprising:
receiving a video signal component over a first communications channel, the video signal component comprising a first video signal constituting a primary video image and a second video signal constituting a secondary video image combined to generate a composite image of the primary and secondary images, and
receiving an instruction signal component comprising instructions to form an interactive television client application program which defines a specified portion of the composite image as a location for a sensitive area; and
transmitting a broadcast signal over a second communications channel to a plurality of viewer locations, the broadcast signal including the video signal component and the instruction signal component.

12. A method for generating a datastream at a control location for implementing an interactive television application at a viewer location, comprising:
receiving a first video signal constituting a primary image;
receiving a second video signal constituting a secondary image;
combining the first and second video signals to form a broadcast video signal representing a composite of the primary and secondary images;
receiving a specification of a predetermined location in at least one of the primary and secondary image as a specified portion of the composite image;
generating instructions to form an interactive television client application program which renders a specified portion of the composite image as a location for a sensitive area and which generates a first screen containing the primary and secondary images and, in response to viewer input, generates a plurality of secondary screens including the secondary video image;
outputting the instructions and the broadcast video signal for transmission to a customer location.

13. A method as recited in claim 12 comprising combining the instructions with the broadcast video signal and outputting the combined signal for transmission to a customer location.

14. A method for implementing an interactive television application at a viewer location, comprising:
receiving a composite signal at the viewer location over a communications channel, the composite signal including video signals representing an image comprising a primary portion and a secondary portion, including instructions for generating a sensitive area, and signals representing data for a virtual channel display;
processing the signals representing data and caching the data at the customer location;
processing the video signal at the viewer location to generate the image;
processing the interactive signal at the viewer location to generate a sensitive area on the image;
receiving a viewer input selecting the sensitive area; and
retrieving the cached data to generate a virtual channel video display which includes rendering the secondary portion visible.

15. A method for implementing an interactive television application at a viewer location, comprising:
receiving a composite signal at the viewer location over a communications channel, the composite signal including:
video signals representing an image comprising a primary portion and a secondary portion,
instructions for generating at least first and second sensitive areas,
signals representing data for at least first and
second virtual channel displays;
processing the signals representing data and caching the data at the viewer location;
processing the video signals at the viewer location to generate the image;
executing the instructions at the viewer location to generate at least first and second sensitive area displays overlaid upon the image;
receiving a viewer input selecting the first sensitive location;
responding to selection of the first sensitive location by retrieving and processing cached data to generate a first virtual channel video display which includes rendering visible the secondary portion of the image;
receiving a viewer input selecting the second sensitive location;
responding to selection of the second sensitive location by retrieving and processing cached data to generate a second virtual channel video display which includes rendering visible the secondary portion of the image.

16. A method for implementing an interactive television application at a viewer location, comprising:
receiving a composite signal at the viewer location over a communications channel, the composite signal including:
signals representing at least first and second enhanced video display screens, and
signals including instructions for generating sensitive areas at specified locations on the first and second enhanced video display screens for receiving viewer purchase requests;
receiving viewer input specifying a first desired enhanced video display screen;
processing the video signals at the viewer location to generate a video display of the first desired enhanced video display screen;
processing the instructions at the viewer location to generate a first sensitive area display overlaid upon the video display at the specified screen location on the first desired enhanced video display screen;
receiving a viewer input selecting the first sensitive area to request a first purchase;
storing data specifying the first purchase request in a purchase buffer;
receiving viewer input specifying a second desired enhanced video display screen;
processing the video signals at the viewer location to generate a video display of the second desired enhanced video display screen;
processing the instructions at the viewer location to generate a second sensitive area display overlaid upon the video display at the specified screen location on the second desired enhanced video display screen;
receiving a viewer input selecting the second sensitive area to request a second purchase;
storing data specifying the second purchase request in the purchase buffer;
responding to a viewer request by displaying data representing the first and second purchase requests stored in the purchase buffer;
displaying sensitive areas to receive one of a viewer request to cancel the first and second purchases and a viewer request to execute the first and second purchases; and
generating purchase request signals if a viewer request to execute the purchases is received.

17. A method for implementing an interactive television application at a viewer location, comprising:
receiving a first video signal constituting a primary image;
receiving a second video signal constituting a secondary image;
combining the first and second video signals to form a broadcast video signal representing a composite of the primary and secondary images;
receiving a specification of a predetermined location in at least one of the primary and secondary image as a specified portion of the composite image;
generating instructions for causing a broadcast receiver to render the specified location of the secondary image within the composite image as a sensitive area to implement a desired interactive television operation;
combining the broadcast video signal and generated instructions to form a composite broadcast data stream;
transmitting the composite broadcast data stream to a viewer location;
receiving a third video signal constituting a secondary image;
combining the first and third video signals to form a second broadcast video signal representing a composite image which includes the primary and secondary images at the specified locations within the composite image;
defining the specified location of the secondary image within the composite image as a location for a sensitive area;
generating instructions for causing a broadcast receiver to render the specified location of the secondary image within the composite image as a sensitive area to implement a desired interactive television operation;
combining the second broadcast video signal and the generated instructions to form a second composite broadcast data stream; and
transmitting the second composite broadcast data stream to a viewer location.

18. A method for generating a datastream at a control location for implementing an interactive television application at a viewer location, comprising:
receiving a video signal constituting an image;
defining a first specified portion of the image as a location for a first sensitive area;
generating first instructions for causing a broadcast receiver to render the first specified image portion as a sensitive area to implement a first interactive television operation;
defining a second specified portion of the image as a location for a second sensitive area; and
generating second instructions for selectively causing a broadcast receiver to render the second specified image portion as a sensitive area to implement a second interactive television operation;
the first interactive television operation rendering the second sensitive area visible on a display screen and enabling the second instructions.

19. A method for generating a datastream at a control location for implementing an interactive television application at a viewer location, comprising:
receiving a first video signal constituting a primary image;
receiving a second video signal constituting a secondary image;
combining the first and second video signals to form a broadcast video signal representing a composite of the primary and secondary images;
outputting the broadcast video signal for transmission to a customer location generating first instructions to form an interactive television client application program which renders a specified portion of the composite image as a location for a sensitive area;
receiving an operator input calling for expansion of display of the primary image so as to cover at least a part of the secondary image at a viewer location;
responding to the operator input by generating second instructions in the interactive television client application program to display the primary signal in a full-frame mode at the viewer location;
outputting the first and second instructions to the viewer location.

20. A method as recited in claim 19 wherein the operator input includes a specific time for suppression of display of the secondary image at a viewer location.

21. A method for implementing an interactive television application at a viewer location, comprising:
receiving a composite signal at the viewer location over a communications channel, the composite signal including video signals representing an image comprising a primary portion and a secondary portion, an interactive signal including instructions for generating a plurality of sensitive areas, and signals representing data for a virtual channel display;
processing the signals representing data and storing the data at the customer location;
processing the video signal at the viewer location to generate the image;
processing the interactive signal at the viewer location to generate a first sensitive area on the image;
receiving a viewer input selecting the first sensitive area;
retrieving the stored data to generate a virtual channel video display which includes rendering the secondary portion visible;
processing the interactive signal at the viewer location to generate a second sensitive area on the image to receive viewer input of a customer I.D. number;
receiving a viewer input in the second sensitive area to store a customer I.D. number; and
processing the interactive signal at the viewer location to initiate a purchase transaction using the customer I.D. number.

22. A method as recited in claim 21, wherein the instructions generating the sensitive areas include category information, the customer I.D. number includes a permission level, and the stage of processing the interactive signal at the viewer location to generate a second sensitive area on the image to receive viewer input of a customer I.D. number includes selectively executing a purchase transaction based on a comparison of the category information and the permission level.

23. A method for implementing an interactive television application at a viewer location, comprising:
receiving a composite signal at the viewer location over a communications channel, the composite signal including video signals representing an image and an interactive signal including instructions for generating a plurality of sensitive areas;
processing the video signal at the viewer location to generate the image;
processing the interactive signal at the viewer location to generate a first sensitive area on the image comprising an interactive ad display;
receiving a viewer input selecting the first sensitive area;
processing the interactive signal at the viewer location to generate a second sensitive area on the image to receive viewer input of a customer I.D. number;
receiving a viewer input in a second sensitive area to store a customer I.D. number; and
processing the interactive signal at the viewer location to initiate an interactive ad activity using the customer I.D. number.

24. A method as recited in claim 23, wherein the instructions generating the sensitive areas include category information, the customer I.D. number includes a permission level, and the stage of processing the interactive signal at the viewer location to generate a second sensitive area on the image to receive viewer input of a customer I.D. number includes selectively executing an interactive ad activity based on a comparison of the category information and the permission level.

25. A system for generating a datastream at a control location for implementing an interactive television application at a viewer location, comprising:
a video switcher which receives a first video signal constituting a primary image and a second video signal constituting a secondary image, combines the first and second video signals to form a broadcast video signal representing a composite of the primary and secondary images, and outputs the broadcast video signal for transmission to a customer location;
a content staging server which receives a specification of a predetermined location in at least one of the primary and secondary image as a specified portion of the composite image; and
an interactive TV server component coupled to the content staging server which generates instructions to form an interactive television client application program to render the specified portion of the composite image as a location for a sensitive area and outputs the instructions for transmission to a viewer location.

26. A set-top box for implementing an interactive television application at a viewer location, comprising:
an input terminal for receiving a composite signal at the viewer location over a communications channel, the composite signal including video signals representing an image comprising a primary portion and a secondary portion, including instructions for generating a sensitive area, and signals representing data for a virtual channel display;
a processor coupled to the input terminal for processing the signals representing data and caching the data and for processing the interactive signal at the viewer location to generate a sensitive area on the image;
an audio-video output circuit coupled to the input terminal to process the video signal and supply an audio-video output signal for output to a display device;
a remote control receiver circuit responsive to viewer inputs to highlight and select the sensitive area; and
the processor retrieving the cached data to generate a virtual channel video display which includes rendering the secondary portion visible.

27. A system for generating a datastream at a control location for implementing an interactive television application at a viewer location, comprising:
a video switcher which receives a first video signal constituting a primary image; and
a second video signal constituting a secondary image, combines the first and second video signals to form a broadcast video signal representing a composite of the primary and secondary images, and outputs the broadcast video signal for transmission to a viewer location;
a content staging server which receives a specification of a predetermined location in at least one of the primary and secondary image as a specified portion of the composite image and which generates a command upon receipt of an operator input calling for expansion of display of the primary image so as to cover at least a part of the secondary image at a viewer location;
an interactive TV server component coupled to the content staging server which generates first instructions to form an interactive television client application program which renders a specified portion of the composite image as a location for a sensitive area and, in response to the command, generates second instructions in the interactive television client application program to display the primary signal in a full-frame mode at the viewer location, the interactive TV server component outputting the first and second instructions, signal for transmission to the viewer location.
